(19) United States
(12) Patent Application Publication
(10) Pub. No.: US 2010/0263694 A1
(43) Pub. Date: Oct. 21, 2010

(54) DECOATING DEVICE FOR AXIALLY SYMMETRIC COMPONENTS, PARTICULARLY FROM AIRCRAFT ENGINES

(75) Inventors: Thomas Uihlein, Dachau (DE); Wolfgang Eichmann, Puchheim (DE); Falko Heutling, Muenchen (DE); Markus Uecker, Muenchen (DE); Thomas Brendel, Petershausen (DE); Georgios Paronis, Augsburg (DE); Anton Albrecht, Bad Koetzting (DE); Manfred Berger, Vierkirchen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/312,273

(22) PCT Filed: Oct. 27, 2007
(86) PCT No.: PCT/DE2007/001934

§ 371 Date: Jun. 9, 2010

(30) Foreign Application Priority Data
Nov. 3, 2006 (DE) 102006051812.8

(51) Int. Cl. B08B 3/00

(52) U.S. Cl. 134/105; 134/137

(57) ABSTRACT

A decoating device for axially symmetric components, particularly from aircraft engines is provided, the decoating process being carried out through the use of a decoating fluid-which is brought on a localized basis into contact with the component to be decoated, a receptacle for holding the decoating fluid being provided that rotates at least about one axis of rotation, and the decoating fluid surface forming a rotation paraboloid in response to the rotation, the component(s) to be decoated on a localized basis being accommodated in the receptacle and being dipped on the radially outer side into the decoating fluid. A decoating device is thereby devised which makes it possible for radially symmetric components to be decoated in the radially outer region in a simple process.

Priority is claimed to German Patent Application DE 10 2006 051 812.8. filed Nov. 3, 2006 through international application PCT/DE2007/001934, filed Oct. 27, 2007, the entire disclosures of which are hereby incorporated by reference herein.

The present invention relates to a decoating device for axially symmetric components, particularly from aircraft engines, such as blade elements of a BLISK component, the decoating process being carried out using a decoating fluid which is brought into contact with the component to be decoated on a localized basis.

### BACKGROUND OF THE INVENTION

Components from aircraft engines, such as blade elements, which are configured on a BLISK component, are often provided with a coating. These coatings, which often differ, include erosion-protection coatings, oxidation-resistance coatings, anticorrosive coatings or also heat-protection coatings at the surfaces of the blade elements. The BLISKs are composed of a disk, the “dISK” having blade elements, commonly referred to as “BLades,” which are configured radially outwardly on the periphery, individually distributed over the same.

The blade elements are preferably provided with blade-tip hardfacing material to allow the blades to rub against a casing at a low rate of wear. However, for repair purposes, it is typically necessary to remove or ablate the coating in some areas, partially or also completely from the blade element to be repaired. The process of removing or ablating coatings is also described as decoating. The related art differentiates among mechanical, chemical or electrochemical decoating methods.

In the case of chemical decoating, methods are known which provide for bringing the components to be decoated into contact with a decoating fluid in a dipping process. In this context, the component to be decoated is completely immersed into an electrochemical bath, so that not only the coated, but all surfaces of the component are subjected to an attack on materials. A localized immersion of the coated regions of the component is often greatly limited by the component geometry, which poses limitations due to the use of the BLISKs on the radially outer periphery. The use of protective coverings for the uncoated regions of the component leads to interfacial reactions due to a limited wettability and, thus, to an uncontrolled attack on the uncoated regions.

However, it is considered that a prerequisite for technically implementing BLISK coatings is that the coated components always be able to be decoated.

The decoating of components using chemical processes is often referred to as stripping, and it is preferred for production applications. For this purpose, a number of different stripping approaches and process sequences for decoating erosion-protection coatings are sufficiently known.

The German Patent Application DE 101 28 507 A1 describes a device used for the localized decoating of components, a holding device for a component having a coating at least on sections thereof, and at least one receiving device for an absorbent medium that contains a decoating fluid being provided. The holding and/or the receiving devices are able to be positioned relative to one another in such a way that the medium containing the decoating fluid contacts the component region to be decoated. An absorbent cotton, a sponge or a ceramic- or synthetic-based porous material is provided as a medium for holding the decoating fluid.

There are a number of disadvantages associated with this known approach for partially decoating components, as well as with commonly used techniques which provide for covering the component regions to be protected. Lacquer, wax or encapsulations which entail the use of covering devices are provided for covering the component regions to be protected. When working with each of these covering techniques, the entire component is typically dipped into the stripping solution, the covered component regions not being wetted with the stripping solution. Generally, the covering process prior to the stripping operation entails high costs. The processing times entailed in a series production are often not acceptable, most notably when working with lacquer or wax methods. In addition, it is only possible to use encapsulation to cover the component regions to be protected when working with simple component geometries. It is often not possible to use encapsulation techniques to protect curved or spherical surfaces of undercuts at a justifiable cost since the complex contours, for example of the intake side or thrust side of blade elements, necessitate an equally complex contour of the covering. Another problem arises at the transition from the wetted, i.e., not covered, to the unwetted, covered surface. Commonly used protective coverings have infiltration tendencies, so that a sharp delimitation is not possible in most cases. Also, the stripping process can lead to step-like formations in the transitional region whose notch effect is unacceptable due to reasons relating to the strength of the blade element or of the BLISK.

When working with the disk-shaped BLISKs, the use of a dipping solution is frequently ruled out since only the radially outwardly configured blade elements need to be brought into contact with the decoating fluid. A simple dipping is not possible since a bath of the decoating fluid merely permits a dipping in the vertical direction.

### SUMMARY OF THE INVENTION

It is, therefore, an object of the present invention to devise a decoating device for decoating components from aircraft engines that avoids the related-art disadvantages and renders possible a simple decoating of radially symmetric components in the radially outer region.

The present invention incorporates the technical teaching whereby a receptacle for holding the decoating fluid is provided that rotates at least about one axis of rotation, and the decoating fluid surface forms a rotation paraboloid in response to the rotation, the component(s) to be decoated on a localized basis being accommodated in the receptacle and being dipped on the radial outer side into the decoating fluid.

The advantage of the approach according to the present invention resides in the creation of an annular decoating bath which is constituted of the decoating fluid itself. In response to the rotation of the receptacle, the decoating fluid contained therein is likewise set into rotation. For this purpose, the decoating device has a receptacle into which the component to be decoated may be mounted or from which it may be dismounted. Thus, the receptacle and the component to be decoated are securely affixed to one another and mounted in a rotating device. On the whole, therefore, a carousel-type device is devised which sets the receptacle, along with the component to be decoated and the decoating fluid contained therein, into rotation. In the process, the receptacle makes it possible for the decoating fluid to either be directly received, or a suitable supplying of the decoating fluid is at least possible.

If the carousel-type receptacle along with the decoating fluid is set into rotary motion, then a centrifugal force acts on the decoating fluid. In this context, this centrifugal force, also described as flywheel force, is directed away from the axis of rotation, so that an outwardly directed centrifugal force acts on the fluid perpendicularly to the direction of rotation. Therefore, given a high enough speed, the decoating fluid is pressed into the outer region of the receptacle. The rotation of the total system composed of the receptacle, the decoating fluid, as well as of the component to be decoated results in a paraboloidal deformation of the surface of the decoating fluid and thereby permits a selective wetting of the outer regions of the axially symmetric component to be decoated. By selecting the geometry and properly configuring the BLISK component and the geometry of the receptacle, an annular decoating bath forms. Therefore, the entire blade ring assembly of the BLISK component is immersed into the annular decoating bath and is thus wetted with the decoating fluid. On the other hand, the inner BLISK regions, which do not need to be decoated, remain unwetted by the decoating fluid.

Thus, the BLISK component is not able to be completely wetted by the decoating fluid using the decoating device according to the present invention. Thus, the need for providing additional protective covering for those component surfaces which must not be wetted by the coating fluid, is completely eliminated. The decoating process may be selectively regulated via the filling level of the decoating fluid, the speed of the receptacle, the immersion depth of the component to be decoated, as well as the form of the wetting horizon on the blade ring assembly. Between the wetted and unwetted surface, a sharp boundary forms which limits the action of the decoating fluid to only the surface region to be decoated. By varying the fluid level of the decoating fluid, thus the filling capacity during the process of decoating a component, it is possible to distribute the transitional region between the decoated and the non-decoated surface of the component over a relatively large component surface. In this context, the filling capacity is changed during operation of the decoating device.

One advantageous specific embodiment of the present invention provides for the component to be decoated to be a BLISK component and/or a BLING component and to be able to be accommodated within the receptacle, the component corotating with the rotary receptacle. BLING components are distinguished from BLISK components essentially in that an annular inner part is provided for accommodating the blade elements, and the component thus includes outer “BLades” and an inner “rING.”

The device advantageously includes a mounting disk for accommodating individual blade elements thereon within the receptacle in order to be able to configure the same axially symmetrically, in a radially outwardly directed manner. Thus, in the same manner, individual blade elements may also be brought into contact with the decoating fluid within the annular decoating bath. Therefore, a plurality of possible applications are possible in accordance with the present invention, so that the decoating device may be used for decoating blades, blade-tip hardfacing material, aluminized coatings, as well as heat-insulation coatings, i.e., what are commonly referred to as hot-gas anticorrosive coatings.

In accordance with another advantageous specific embodiment, the device includes a heating device for completely or partially heating the decoating fluid. The heating device corresponds to a supplementary device which is capable of heating the decoating fluid within the receptacle. Thus, the advantage is derived that, by heating the decoating fluid, the duration of the decoating process may be shortened. Below a minimum temperature, many chemical reactions, which are required for the decoating process, take place only very slowly or not at all. The heating device may be mounted directly on the rotating decoating receptacle or, for example, also act on the decoating fluid by irradiating the same.

Another advantageous specific embodiment provides that the device include a cooling device for cooling the decoating fluid. Upon termination of a decoating cycle, it is advantageous to cool the decoating fluid since a rapid cooling of the decoating fluid following completion of the decoating process, prior to reduction of the carousel speed, counteracts any encrustation of salts from the decoating fluid on the inner walls of the receptacle.

Another advantageous specific embodiment of the present invention provides that the axis of rotation of the decoating device be spatially variable, so that it may be oriented horizontally, vertically, or at any given angle relative to the horizontal. The vertical describes the direction of gravity, so that the horizontal is rotated 90° relative to the vertical. Thus, when working with an inclined mode of operation of the decoating device, by coordinating the component geometry and the component shape, as well as the attainable surface of the decoating fluid, an altered rotation paraboloid is derived, thereby making it possible to modify the decoating boundary on the component.

In accordance with another advantageous specific embodiment, the device includes one or more fluid receptacles capable of holding the decoating fluid during operation. Some of the decoating processes are based on a sequence of stripping cycles which employ different stripping solutions. To be able to use a decoating device according to the present invention for these types of decoating processes as well, which necessitate changing the stripping solution during operation, an important prerequisite is replacing the stripping solution. For this purpose, two or more reservoirs may be integrated on the outside or inside of the axially symmetric receptacle. They receive or release the desired stripping solution depending on the stripping cycle. Suitable devices may be used for filling and emptying the receptacle, it also being possible for the devices to be conceived in a way that makes it possible for filling and emptying to be carried out during operation, i.e., during rotation of the receptacle. In addition, it may be advantageous to adapt the volume of the stripping bath to the size of the component surface to be decoated. In this context, the volume of the stripping solution and the chemical reactivity of the stripping solution and of the component surface to be decoated of the volume to be ablated are mutually coordinated. The volume of the stripping bath is selected in such a way that the stripping solution is depleted following the decoating of the component and is no longer chemically reactive.

For that reason, it is provided that, on its bottom side, the receptacle have an annular, peripheral stock volume in which the decoating fluid is stored while the receptacle is at standstill. If, at this point, the receptacle is set into rotation, its contour is suitably adapted for holding the decoating fluid and for adapting the filling capacity. A working volume is created by way of this adapted contour; to adapt the filling quantity of the decoating fluid, the receptacle including an axially symmetric, peripheral working volume into which the decoating fluid is received during operation of the receptacle. Only upon deceleration or standstill of the receptacle does the decoating fluid flow back into the stock volume since the centrifugal force does not continue to act on the decoating fluid.

### BRIEF DESCRIPTION OF THE DRAWINGS

The present invention is described in greater detail with reference to the figures, without being limited thereto. The figures show:

FIG. 1 a schematic cross-sectional view of the decoating device including a decoating fluid which is contained within a receptacle;

FIG. 2 a half cross section of the decoating device including a receptacle, the decoating device being shown in the stationary state; and

FIG. 3 a half cross section of the decoating device, the decoating device being in operation.

### DETAILED DESCRIPTION

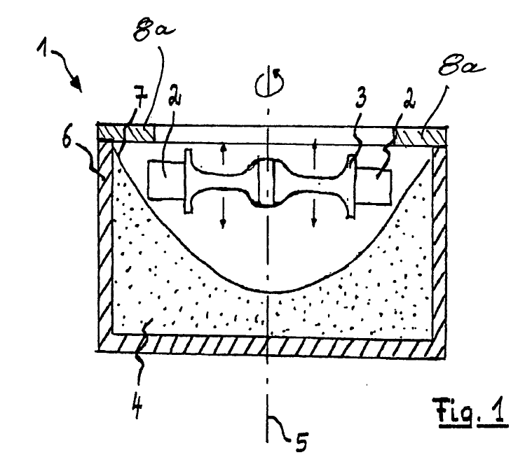

Decoating device 1 shown in FIG. 1 is used for decoating blade elements 2 which are configured radially outwardly on an axially symmetric BLISK component 3. Decoating device 1 includes a receptacle 6 in which a decoating device 4 is contained. Receptacle 6 may be set into rotation about an axis of rotation 5, so that decoating fluid 4 likewise rotates. In response to the rotary motion of decoating fluid 4, a paraboloid-type contour forms in decoating fluid surface 7. As a function of the speed of receptacle 6, the centrifugal force acts horizontally on decoating fluid 4 so intensely that an annular decoating bath may be formed. To ensure that fluid does not escape, an annular lid 8a may also be placed on receptacle 6. If, at this point, BLISK component 3 having the radially outwardly configured blade elements 2 is dipped into the decoating bath, then merely blade elements 2 or even only the outer regions of blade elements 2 are wetted with decoating fluid 4. For this, BLISK component 3 must be moved in the vertical direction to determine the immersion depth of blade elements 2 into decoating fluid 4. The vertical motion of BLISK component 3 is indicated by two arrows which point upwards and two arrows which point downwards.

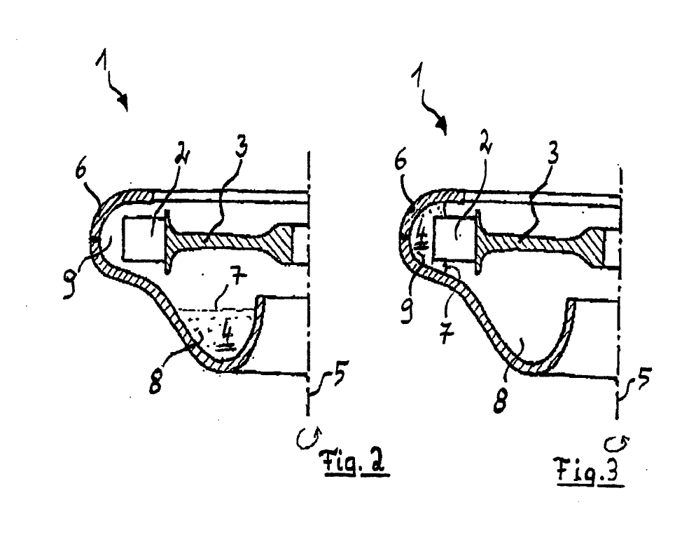

FIGS. 2 and 3 each show a half section through receptacle 6 of decoating device 1. In accordance with the representation in FIG. 2, decoating fluid 4 is located in a stock volume 8 within receptacle 6, stock volume 8 being provided on the bottom side of receptacle 6. If decoating device 1 is in the state of rest shown here, then merely the force of gravity acts on decoating fluid 4, so that it is contained within stock volume 8.

In accordance with the representation in FIG. 3, decoating device 1 is in operation, so that receptacle 6 and decoating fluid 4 rotate about axis of rotation 5. Due to the centrifugal force acting thereon, decoating fluid 4 flows out of stock volume 8 and fills a radial, peripheral working volume 9. At this point, blade elements 2 are immersed within decoating fluid 4, the decoating fluid being configured to extend annularly, peripherally within receptacle 6. Only upon renewed deceleration and at standstill of the receptacle does decoating fluid 4 flow back into stock volume 8, and BLISK component 3 may be removed from decoating device 1.

Decoating device 1 may be suited, in particular, for chemical and/or electrochemical processes. In one advantageous design, the receptacle may be completely or partially used as a counter-electrode for the component, preferably as a cathode. It may also be provided for entraining elements to be used in region 4.

The present invention is not limited in its practical implementation to the preferred exemplary embodiment indicated above. Rather, a number of variants which utilize the described approach are conceivable, even in the context of fundamentally different executions.

1-12. (canceled)

13. A decoating device for axially symmetric components, particularly from aircraft engines, the decoating process being carried out through a decoating fluid brought on a localized basis into contact with the component to be decoated, the device comprising:
a receptacle for holding the decoating fluid being provided, the receptacle rotating at least about one axis of rotation, and the decoating fluid surface forming a rotation paraboloid in response to the rotation, the component to be decoated on a localized basis being accommodated in the receptacle and being dipped on the radially outer side into the decoating fluid, the component to be decoated being accommodated within the receptacle in corotation therewith.

14. The decoating device as recited in claim 13, wherein the component to be decoated is a BLISK component and/or a BUNG component.

15. The decoating device as recited in claim 13, wherein the device includes a mounting disk for accommodating individual blade elements thereon within the receptacle in order to be able to configure the same axially symmetrically, in a radially outwardly directed manner.

16. The decoating device as recited in claim 13, further comprising a heating device for completely or partially heating the decoating fluid.

17. The decoating device as recited in claim 13, further comprising a cooling device for cooling the decoating fluid.

18. The decoating device as recited in claim 13, wherein the axis of rotation of the decoating device is spatially variable, so that it may be oriented horizontally, vertically, or at any given angle relative to the horizontal.

19. The decoating device as recited in claim 13, wherein the fluid receptacle is capable of holding the decoating fluid during operation.

20. The decoating device as recited in claim 19, wherein, for the decoating process, a plurality of decoating fluids are provided to be used in succession and are replaceable during operation of the device, the decoating fluids within the receptacle are able to be received from the receptacle and fed into the same again.

21. The decoating device as recited claim 13, wherein the receptacle has an axially symmetric design.

22. The decoating device as recited in claim 13, wherein, on the bottom side, the receptacle has an annular, peripheral stock volume in which the decoating fluid is stored while the receptacle is at standstill.

23. The decoating device as recited claim 13, wherein, to adapt the filling quantity of the decoating fluid, the receptacle is adapted to the contour of the component to be decoated.

24. The decoating device as recited in claim 23, wherein, to adapt the filling quantity of the decoating fluid, the receptacle includes an axially symmetric, peripheral working volume within which the decoating fluid is held during operation of the receptacle.
